(19) United States
(12) Patent Application Publication
(10) Pub. No.: US 2024/0153315 A1
(43) Pub. Date: May 9, 2024

(54) CUSTOMER MONITORING AND REPORTING DEVICE, AND CUSTOMER MONITORING AND REPORTING METHOD

(71) Applicant: Toshiba Tec Kabushiki Kaisha, Tokyo (JP)

(72) Inventor: Hidehiro NAITO, Mishima Shizuoka (JP)

(21) Appl. No.: 18/356,188

(22) Filed: Jul. 20, 2023

(30) Foreign Application Priority Data
Nov. 9, 2022 (JP) 2022-179325

(51) Int. Cl. G06V 40/20; G06V 20/40

(52) U.S. Cl. CPC G06V 40/28; G06V 20/46

(57) ABSTRACT

According to one embodiment, a customer monitoring device receives video data and has a processor. The processor extracts feature data of items on a table in the video data, recognizes the items, and sets an article flag in a data record associated with the table to a positive value if an item on the table is recognized as an empty plate or empty glass. The processor also extracts feature data of a person proximate to the table from the video data, estimates a skeleton position of the person and generates skeleton data for the person. A first operation flag in the data record is set to a positive value if the generated skeleton data indicates the person has performed an ordering action. A notification is output to a notification unit if at least one of the article flag and the first operation flag is a positive value.

### CROSS-REFERENCE TO RELATED APPLICATION

This application is based upon and claims the benefit of priority from Japanese Patent Application No. 2022-179325, filed Nov. 9, 2022, the entire contents of which are incorporated herein by reference.

### FIELD

Embodiments described herein relate generally to a customer monitoring and reporting device and a customer monitoring and reporting method.

### BACKGROUND

According to the related art, in an eating and drinking place such as a restaurant, a customer monitoring device that monitors an action of a customer in order to swiftly take an order from a customer wishing to eat and drink inside the place is provided. The customer monitoring device is connected to an image pickup unit (e.g., a camera) and acquires an image or a video showing the state inside the shop. The customer monitoring device recognizes a customer in the acquired image or video. If the customer makes a noticeable movement or gesture based on a movement of the hands and the face, the customer monitoring device determines that the customer is trying to call a shop attendant, and therefore notifies the shop attendant a customer appears to be requesting to place an order.

However, if the movement/gesture of the customer is too small to reach a noticeability threshold, the customer monitoring device does not notify the shop attendant. In such a case, the shop attendant misses the opportunity to take an order from the customer.

### BRIEF DESCRIPTION OF THE DRAWINGS

FIG. 1 is a block diagram showing an example of a customer monitoring system according to a first embodiment.

FIG. 2 is a block diagram showing an example of a customer monitoring device.

FIG. 3 is a functional block diagram showing an example of the functional aspects of the customer monitoring device.

FIG. 4 shows an example of skeleton data.

FIG. 5 shows an example of the data structure of a flag management file.

FIG. 6 is a flowchart showing an example of customer monitoring processing.

FIG. 7 is a flowchart showing an example of action monitoring processing.

FIG. 8 is a flowchart showing an example of table monitoring processing.

FIG. 9 shows an example of a display image.

FIG. 10 is a flowchart showing an example of action monitoring processing according to a second embodiment.

### DETAILED DESCRIPTION

An embodiment described provides a customer monitoring and reporting device and a customer monitoring and reporting method that prevents an order opportunity from being missed.

In general, according to one embodiment, a customer monitoring device includes a communication interface configured to receive video data and a processor. The processor is configured to: extract feature data of an article on a table from the video data, recognize the article on the table based on the extracted feature data, and set an article flag in a data record associated with the table to a positive value if the article on the table is recognized as an empty plate or empty glass. The processor is also configured to extract feature data of a person proximate to the table from the video data, estimate a skeleton position of the person and generate skeleton data for the person, and set a first operation flag in the data record to a positive value if the generated skeleton data indicates the person has performed a first ordering action. The processor is additionally configured to output a notification instruction to a notification unit if at least one of the article flag and the first operation flag in the data record is a positive value.

### First Embodiment

An embodiment will now be described with reference to the drawings. A customer monitoring device 10 according to this first embodiment performs image recognition of skeleton data M of a customer generated from video data acquired from an image pickup unit 20 installed inside a shop such as an eating and drinking place (restaurant). The skeleton data M may be generated from video data or from individual images extracted from the video data. The customer monitoring device 10 determines whether to enable a flag or not based on the skeleton data M.

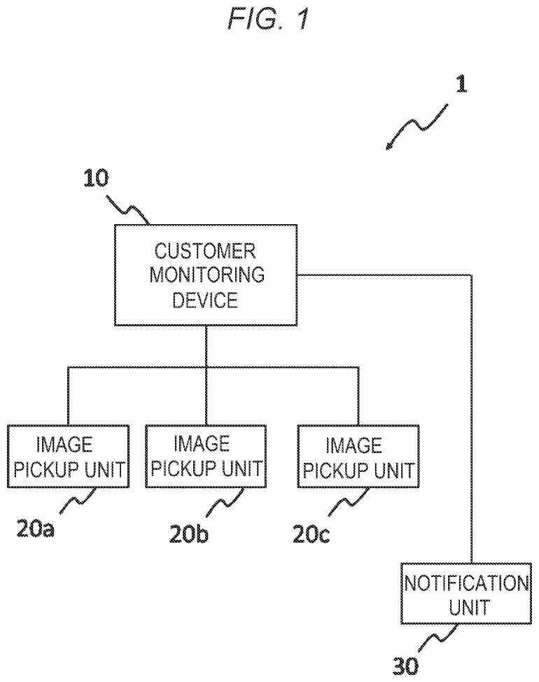

FIG. 1 is a block diagram showing an example of a customer monitoring system 1 according to a first embodiment.

The customer monitoring system 1 includes, for example, the customer monitoring device 10, the image pickup unit 20, and a notification unit 30. These units are connected to each other via a communication network. The communication network is, for example, a LAN (local area network). The LAN may be a wired LAN or a wireless LAN.

The customer monitoring device 10 monitors the movement of a customer and the state of a table in the store. The customer may also be referred to as a client, a shop user, a consumer or the like. The customer monitoring device 10 acquires a video showing the inside of the shop from the connected image pickup unit 20 as video data and monitors the movement of the customer and the state on the table. The customer monitoring device 10 estimates the skeleton of the customer from the acquired video data and generates the skeleton data M, in order to monitor the movement of the customer. The customer monitoring device 10 also uses an image recognition technique to monitor the state of the table at which the customer is located. The customer monitoring device 10 determines whether it is an order opportunity or not based on the skeleton data M and the image of the table in combination. If the customer monitoring device 10 determines that it is an order opportunity, the customer monitoring device 10 transmits a notification instruction to the notification unit 30. Such a customer monitoring device 10 may be an independent device or may be a part of a personal computer installed inside the shop or a server inside or outside the shop.

The image pickup unit 20 receives an image of the inside of the shop. The image pickup unit 20 outputs an image signal based on light received by an image pickup element. The image signal is an electrical signal. Various operations such conversion, compression, and encoding of the signal may be performed. The image pickup unit 20 generates video data (a video feed) in this example. The image pickup unit 20 transmits the video data to the customer monitoring device 10. In generating the video data, the image pickup unit 20 executes, for example, gray scale conversion processing and development processing including noise elimination and scratch correction or the like. The image pickup unit 20 may be located at a different site from the monitored location. Also, a plurality of image pickup units 20 may be arranged in the store (restaurant), such as on a corresponding one-to-one basis for each of a plurality of tables at the store.

The notification unit 30 notifies a shop attendant of an order opportunity. In response to the notification instruction received from the customer monitoring device 10, the notification unit 30 notifies the shop attendant of a table where an order opportunity has occurred. The notification unit 30 has, for example, a lamp for each table and notifies the shop attendant of a particular with an order opportunity by lighting a corresponding lamp. The notification unit 30 may also give a notification via a sound in addition to the notification by lamp.

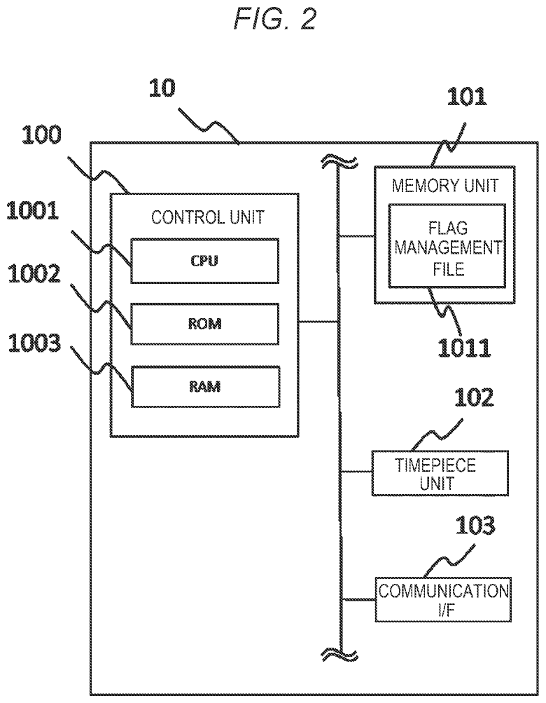

FIG. 2 is a block diagram showing an example of the customer monitoring device according to the first embodiment. The customer monitoring device 10 has a control unit 100, a memory unit 101, a timepiece unit 102, and a communication I/F 103. These units are connected to each other via a bus.

The control unit 100 is formed of a CPU (central processing unit) 1001, a ROM (read-only memory) 1002, and a RAM (random-access memory) 1003. The CPU 1001 controls the entirety of the customer monitoring device 10. The ROM 1002 stores various programs such as a program used to drive the customer monitoring device 10, and various data. The RAM 1003 is used as a work area of the CPU 1001. In the RAM 1003, various programs and various data stored in the ROM 1002 or the memory unit 101 are loaded. As the CPU 1001 operates according to an information processing program stored in the ROM 1002 or the memory unit 101 and then loaded in the RAM 1003, the control unit 100 executes various functional processing of the customer monitoring device 10.

The memory unit 101 can be an HDD (hard disk drive), a flash memory, or the like. The memory unit 101 stores software such as an operating system and other necessary application programs for the customer monitoring device 10 to operate, and user information or the like. The memory unit 101 also stores a flag management file 1011 and may also store video data acquired from the image pickup unit 20 or image data extracted from the video data. In the flag management file 1011, a table number corresponding to each table at the store is listed. The flag management file 1011 may be stored in any storage medium that can be accessed from the customer monitoring device 10. The flag management file 1011 may be stored in an external HDD or server, or a management terminal installed inside the shop, or the like.

The timepiece unit 102 functions as a time information source (a real time clock) for the customer monitoring device 10. The control unit 100 acquires the current date and time based on time information tracked by the timepiece unit 102. When performing processing at a preset time, the control unit 100 may refer to the time tracked by the timepiece unit 102.

The communication I/F 103 is an interface to communicate with the image pickup unit 20 and the notification unit 30. Video data generated by the image pickup unit 20 is taken into the customer monitoring device 10 via the communication I/F 103. A notification instruction output from the customer monitoring device 10 to the notification unit 30 is sent via the communication I/F 103.

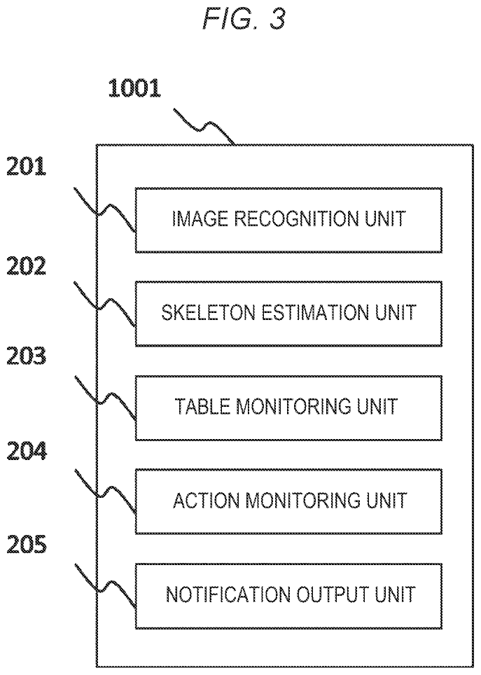

FIG. 3 is a functional block diagram showing an example of the functional configuration of the customer monitoring device 10 according to the first embodiment. The control unit 100 implements an image recognition unit 201, a skeleton estimation unit 202, a table monitoring unit 203, an action monitoring unit 204, and a notification output unit 205 based on the program stored in the ROM 1002 or the memory unit 101.

The image recognition unit 201 recognizes a table and a customer from video data acquired via the image pickup unit 20. The image recognition unit 201 extracts feature data from the acquired video data and thus is able to recognize an object on the table by known image recognition techniques. That is, the image recognition unit 201 may recognize whether a glass, a beer mug, or a plate is on the table based on the feature data extracted from the video data. If fewer image pickup units 20 are provided than the number of tables in the shop, that is, if the method employed is not a method of monitoring each table with one image pickup unit 20, the image recognition unit 201 identifies the table in use by the customers based on the feature data, the location, or the distance of each table.

The image recognition unit 201 recognizes a person from the feature data extracted from the video data, similarly to the recognition of a table.

An example where the image recognition unit 201 recognizes a table and a customer from the video data has been described. However, the image recognition unit 201 may extract an image from the video and may recognize a table and a customer from the extracted image data.

The skeleton estimation unit 202 estimates the position (posture) of the skeleton of the customer recognized by the image recognition unit 201 and generates skeleton data M. As a technique for the skeleton estimation, a known AI technique such as deep learning may be used. The skeleton estimation unit 202 identifies the movements of the customer based on the generated skeleton data M. The skeleton estimation unit 202 can recognize an “order action 1” and an “order action 2” from the movements of the customer. In this embodiment, the skeleton estimation is performed, based on the acquired video. However, the skeleton estimation may be performed on image data extracted from the video.

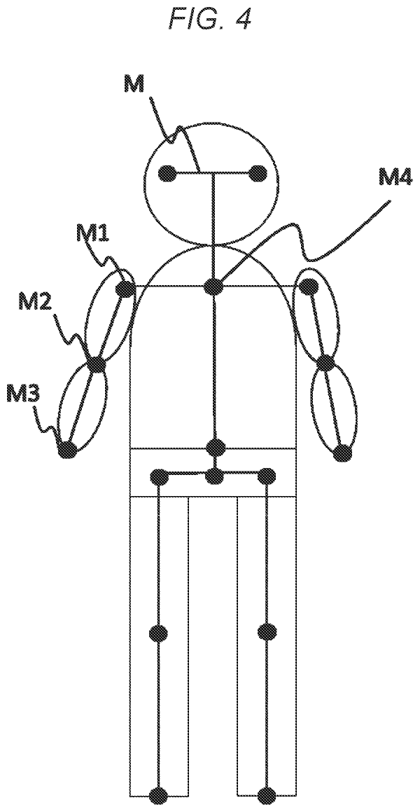

FIG. 4 shows an example of the skeleton data M according to the first embodiment. The skeleton estimation unit 202 performs the skeleton estimation to the customer recognized by the image recognition unit 201. After completing the skeleton estimation, the skeleton estimation unit 202 generates the skeleton data M. In the skeleton data M, a marker is placed at positions necessary for identifying the movement of the body (the customer), such as the eyes, the shoulders, the elbows, and the wrists. For example, if a marker M1 placed at the position of the right shoulder, a marker M2 placed at the position of the right elbow, a marker M3 placed at the position of the right wrist, and a marker M4 set at the center of the chest are located substantially on a straight line, the image recognition unit 201 recognizes that the right arm is stretched in a direction that is rightward and horizontal to the ground surface.

Referring back to FIG. 3, the table monitoring unit 203 monitors the state on the table in use by the customer. The table monitoring unit 203 determines whether an empty glass, beer mug, plate or the like exists or not on the table based on the state on the table recognized by the image recognition unit 201. If it is determined that an empty glass, beer mug, plate or the like exists, the table monitoring unit 203 switches on a flag 3 for the record for the table number corresponding to the table that is being monitored in the flag management file 1011.

The action monitoring unit 204 monitors the movement of the customer based on the skeleton data M generated by the skeleton estimation unit 202. The action monitoring unit 204 recognizes the table and the peripheries thereof as one monitoring area. Such monitoring areas are separated from each other. Therefore, one monitoring area is set for each table. If it is determined that the customer has made the “order action 1” or the “order action 2” within the monitoring area, the action monitoring unit 204 switches on a flag 1 or a flag 2 for table number record in the flag management file 1011. The action monitoring unit 204 recognizes the peripheries of the table as the monitoring area and thus recognizes that the action taken by the customer within the monitoring area is the action taken by the customer using the corresponding table.

A configuration where the action monitoring unit 204 recognizes the monitoring area in order to correlate the table number with the customer has been described as an example. However, the image recognition unit 201 or an independent function may perform this monitoring area recognition. Alternatively, these units may perform the recognition in parallel.

The notification output unit 205 notifies the notification unit 30 that an order opportunity has occurred. The notification output unit 205 checks an enabled flag in the flag management file 1011. If an enabled flag is found, the notification output unit 205 extracts the table number from the corresponding record. After extracting the table number, the notification output unit 205 transmits a notification instruction including the extracted table number to the notification unit 30.

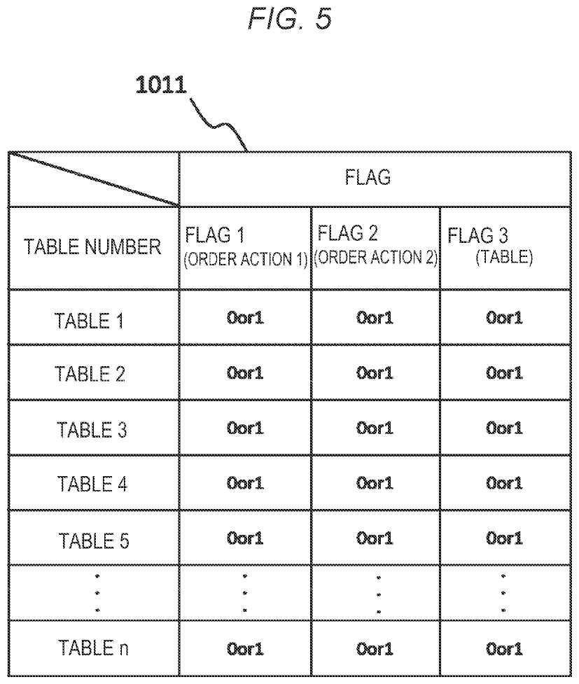

FIG. 5 shows an example of the data structure of the flag management file 1011 according to the first embodiment. The flag management file 1011 is formed of a record where a table number indicates a particular table in the shop and a flag value corresponding to each table number. The flag described in the record is set to either “0” indicating that it is disabled or “1” indicating that it is enabled. As flag values, the flag 1, the flag 2, and the flag 3 may be included in each record. The flag 1 is a flag for an action in which an elbow bending angle reaches a predetermined numeric value (hereinafter referred to as the “order action 1”). Therefore, if it is recognized that the customer has taken the “order action 1,” the flag 1 is turned to “1”, whereas if it is recognized that the customer has not taken the order action 1 or if the flag is reset in customer monitoring processing, the flag 1 is turned to “0”. The flag 2 is a flag for an action in which the customer raises a hand, (hereinafter referred to as the “order action 2”). Therefore, if it is recognized that the customer has taken the “order action 2,” the flag 2 is turned to “1”, whereas if the customer has not taken the “order action 2” or if the flag is reset in the customer monitoring processing, the flag 2 is turned to “0”. The flag 3 is a flag for the case where an empty glass, beer mug or plate is recognized as on the table. Therefore, if it is recognized that a glass or a beer mug from which the customer has finished drinking or a plate from which the customer has finished eating is on the table, the flag 3 is turned to “1”, whereas if a glass or a beer mug in which a drink is left or a plate on which food is left is placed on the table, or if the flag is reset in the customer monitoring processing, the flag 3 is turned to “0”.

In order to determine that the “order action 1” has been performed, the action monitoring unit 204 needs to be able to recognize that the elbow of the customer is bent at a preset angle. The action monitoring unit 204 recognizes the elbow bending angle of the customer from the generated skeleton data M. Specifically, the action monitoring unit 204 defines the marker M2 placed at the right elbow as the origin of the elbow bending angle, measures the angle opening between the marker M1 placed at the shoulder and the marker M3 set at the right wrist, thus measures the elbow bending angle, and determines whether the “order action 1” has been performed or not. The angle at which the action monitoring unit 204 recognizes that the “order action 1” has been performed is, for example, 70 to 100 degrees. In this embodiment, the determination is made based on the elbow bending angle of the right elbow. However, the determination may be made based on the elbow bending angle of the left elbow. The setting of the elbow bending angle from which to determine that the “order action 1” has been performed may be changed.

In order to determine that the “order action 2” has been performed, the action monitoring unit 204 needs to be able to determine that the customer has raised a hand. In this embodiment, raising a hand refers to a state where the marker M3 is located nearer to the head than the marker M1 or the marker M4. In this embodiment, whether a hand is raised or not is determined based on the movement of the right arm. However, the determination may be made based on the movement of the left arm. In that case, a condition that the marker placed at the left wrist is located above the marker M4 or the marker placed at the left shoulder, may be set. Also, the determination may be made based on whether the marker placed at the wrist is located above the marker placed at the elbow or not.

An example of the customer monitoring processing in the case where a customer enters a shop, takes a seat at a table allocated to the table number 1, and uses the table, will now be described. First, before the customer enters the shop, the image pickup unit 20 picks up an image of the inside of the shop and generates video data. After generating the video data, the image pickup unit 20 transmits the video data to the customer monitoring device 10. After the customer monitoring device 10 receives the video data, the image recognition unit 201 recognizes the table and specifies at which table number the customer has sat based on image location or the distance from the camera to the table based on the feature data from the video data or the like. When the customer takes a seat at the table number 1 after entering the shop, the image pickup unit 20 transmits video data to the customer monitoring device 10, and the image recognition unit 201 recognizes the presence of the customer. After the presence of the customer is recognized, the skeleton estimation unit 202 estimates the skeleton of the customer and generates skeleton data M.

The action monitoring unit 204 recognizes peripheries of the table corresponding to the table in use by the customer as the monitoring area and monitors actions of the customer in this area in action monitoring processing. When the customer makes a movement within the monitoring area, if the movement is recognized as the “order action 1,” in which the elbow bending angle is 70 to 100 degrees, or the “order action 2,” in which the wrist is located nearer to the head than the center of the chest or the elbow, the action monitoring unit 204 accesses the flag management file 1011 and enables the flag 1 or the flag 2 in the record for table number 1.

The table monitoring unit 203 checks the status of the table after the lapse of a preset time. If it is confirmed that there is an empty glass, an empty beer mug or an empty plate during this check, the table monitoring unit 203 enables the flag 3 for the table number 1.

The control unit 100 in the customer monitoring device 10 accesses the flag management file 1011 and checks whether there is any table record in which a flag is enabled. If such a record is found, the control unit 100 transmits a notification instruction, resets the flag in the table record, and returns to the action monitoring again.

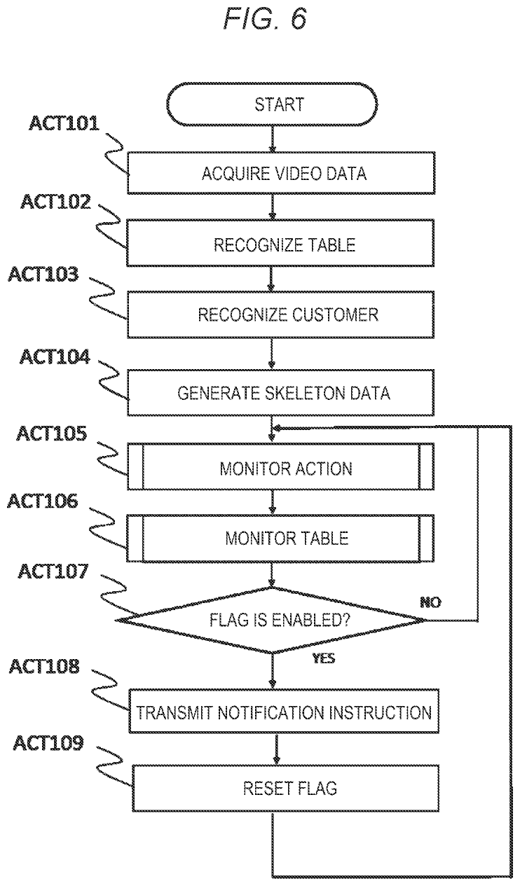

In this first embodiment, a flow of the processing of monitoring the table after performing the action monitoring of the customer is described. However, this is not limiting. The processing of monitoring the table may be performed first. Alternatively, the monitoring of the table and the action monitoring of the customer may be performed in parallel. FIGS. 6 to 8 are flowcharts showing an example of the customer monitoring processing according to the embodiment. FIG. 6 is a flowchart showing an example of the customer monitoring processing according to the first embodiment. In this embodiment, an example where the entire space inside the shop is monitored via a small number of image pickup units 20 is described.

The control unit 100 acquires video data (ACT 101). The control unit 100 acquires the video data from the image pickup unit 20 via the communication I/F 103. The control unit 100 loads the acquired video data into the RAM 1003.

The control unit 100 recognizes a table (ACT 102). The control unit 100 extracts feature data of the table from the video data via the image recognition unit 201 and thus recognizes the table. The control unit 100 also specifies the table number based on the feature data, the location or the distance of the table.

The control unit 100 recognizes the presence of a customer (ACT 103). The control unit 100 recognizes the customer based on feature data of the customer via the image recognition unit 201.

The control unit 100 generates skeleton data M (ACT 104). The control unit 100 estimates a skeleton based on the feature data of the customer recognized via the skeleton estimation unit 202 and generates the skeleton data M. The control unit 100 also places markers M1 to Mn at the eyes, the center of the chest, the two shoulders, the two elbows, the two wrists, and the like in the corresponding skeleton data M.

The control unit 100 performs action monitoring (ACT 105). The control unit 100 monitors actions of the customer via the action monitoring unit 204. If the control unit 100 determines that the “order action 1” or the “order action 2” has been performed based on the monitored movements of the customer, the control unit 100 enables the corresponding flag for the action.

The control unit 100 also performs table monitoring (ACT 106). If the control unit 100 recognizes that there is an empty plate or the like on the table via the table monitoring unit 203, the control unit 100 enables the flag 3.

The control unit 100 checks whether any flag is enabled or not (ACT 107) in a table record. The control unit 100 accesses the flag management file 1011 and checks whether an enabled flag exists or not. If an enabled flag does not exist (NO in ACT 107), the control unit 100 returns to ACT 105.

If the control unit 100 has found an enabled flag in accessing the flag management file 1011 (YES in ACT 107), the control unit 100 gives a notification instruction (ACT 108) corresponding to the enabled flag and table number. The control unit 100 extracts the table number from the flag management file 1011 via the notification output unit 205 and transmits the notification instruction to the notification unit 30 via the communication I/F 103.

After transmitting the notification instruction, the control unit 100 resets the flag (ACT 109). The control unit 100 turns the flag from enabled to disabled in the record for the table number. After resetting the flag, the control unit 100 returns to the processing of ACT 105.

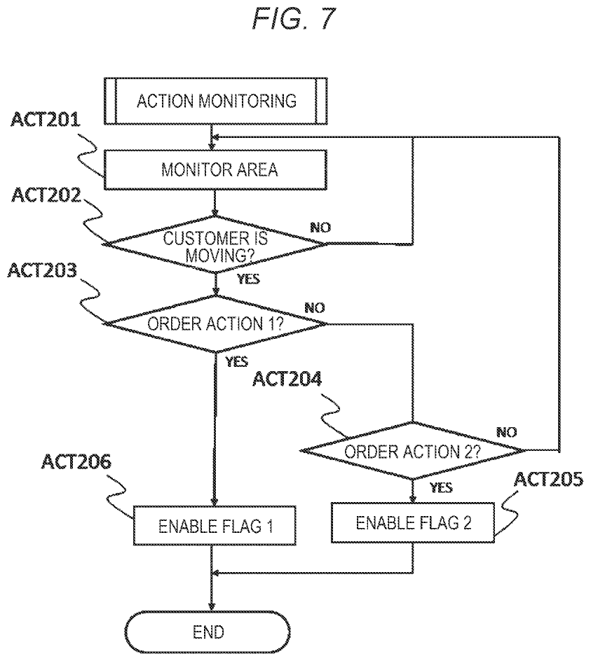

FIG. 7 is a flowchart showing an example of the action monitoring processing according to the first embodiment. The processing for action monitoring is performed by the control unit 100 functioning as the action monitoring unit 204.

The control unit 100 monitors an area (ACT 201). The control unit 100 recognizes the peripheries of the table in use by the customer as one monitoring area, and thus distinguishes whether any action taken is an action taken by the customer at the monitored table or not.

The control unit 100 checks whether the customer is making a movement or not (ACT 202). The control unit 100 monitors whether the customer is moving or not. If the customer is not moving (NO in ACT 202), the control unit 100 returns to ACT 201 and monitors the monitoring area again.

If the customer is making a movement, the control unit 100 checks whether the customer is making the “order action 1” or not (ACT 203). The control unit 100 determines the angle opening between the forearm and the upper arm about the elbow part of the customer as the origin based on the markers M1 to M3. If the elbow bending angle is within a preset angle as the result of the determination (YES in ACT 203), the control unit 100 enables the flag 1 (ACT 206).

If the elbow bending angle is not the preset angle in the determination in ACT 203 (NO in ACT 203), the control unit 100 checks whether the action taken is the “order action 2” or not (ACT 204). If the marker M3 arranged at the wrist is located nearer to the head than the marker M4 arranged at the center of the chest or the marker M2 arranged at the elbow as the result of the checking (YES in ACT 204), the control unit 100 enables the flag 2 (ACT 205).

If the condition to determine that the action taken is the “order action 2” is not met (NO in ACT 204), the control unit 100 returns to ACT 201.

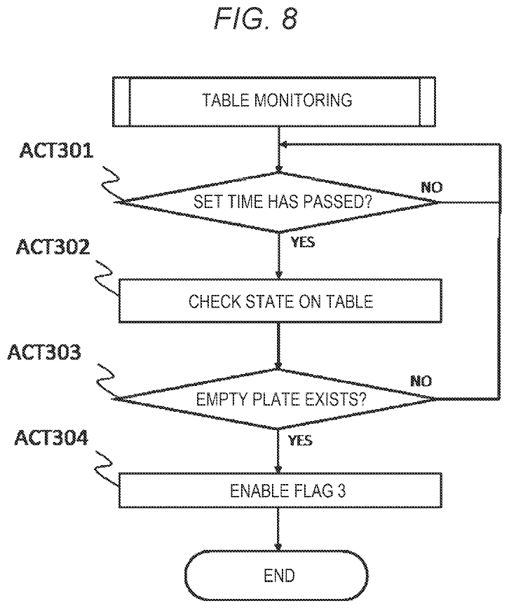

FIG. 8 is a flowchart showing an example of the table monitoring processing according to the first embodiment. The processing for table monitoring is performed by the control unit 100 via the table monitoring unit 203.

The control unit 100 checks whether a set time has passed or not (ACT 301). The control unit 100 accesses the timepiece unit 102 and checks whether the preset time has passed or not. If the preset time has not passed as the result of the checking (NO in ACT 301), the control unit 100 returns to ACT 301.

If the preset time has passed (YES in ACT 301), the control unit 100 checks the state on the table (ACT 302).

The control unit 100 checks whether an empty plate or the like exists or not based on the feature data of the state on the table (ACT 303). If an empty plate, an empty glass, an empty beer mug or the like is not identified (NO in ACT 303), the control unit 100 returns to ACT 301.

If an empty plate, an empty glass, an empty beer mug or the like is identified (YES in ACT 303), the control unit 100 enables the flag 3 (ACT 304).

Such a configuration enables the customer monitoring device 10 to notify the shop attendant without missing an opportunity to take an order.

### Second Embodiment

As a second embodiment, the customer monitoring device 10 also checks whether the customer is performing a grasping action of holding a container such as a cup in a hand or not, when determining whether the customer is performing the “order action 1” or not. Of the elements in the second embodiment, the same elements as the elements in the embodiment shown in FIGS. 1 to 8 are denoted by the same reference signs.

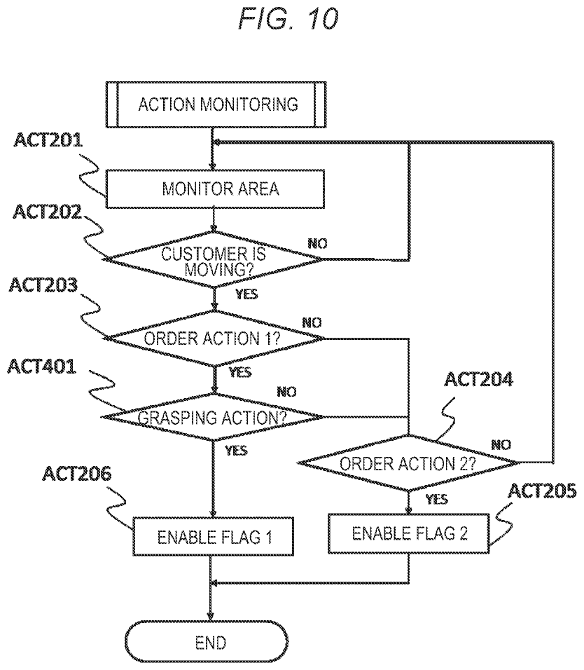

FIG. 10 is a flowchart showing an example of the action monitoring processing according to the second embodiment. After confirming the “order action 1” has been performed, the control unit 100 next checks whether the customer is holding a glass or the like (ACT 401). The control unit 100 checks whether a container such as a glass can be recognized near the marker M3 or not as a function of the image recognition unit 201. In other words, the control unit 100 checks whether the customer was holding a glass, a beer mug or the like when the “order action 1” was performed. If a grasping action (cup holding) is recognized (YES in ACT 401), the control unit 100 enables the flag 1.

If a grasping action is not recognized (NO in ACT 401), the control unit 100 shifts to the processing of checking the “order action 2.”

In such an example, the customer monitoring device 10 can similarly give a notification without missing an order opportunity and can reduce incorrect notification.

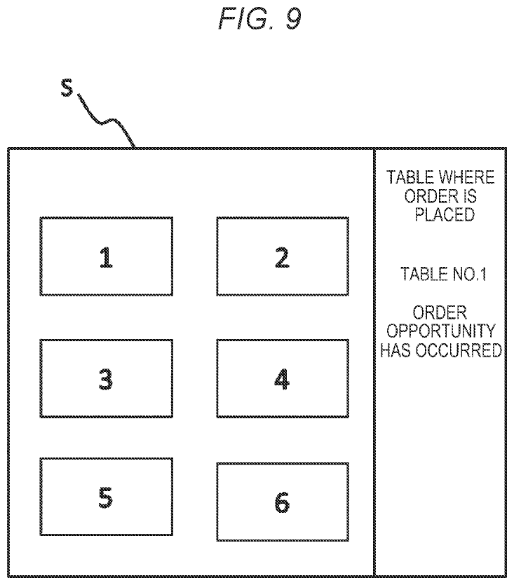

The embodiments of the present disclosure are not limited to the above examples and those already described may be modified in various manners. For example, notification unit 30 may have a display unit for displaying the status in the shop and may display an image S such as shown in FIG. 9. In this case, the notification output unit 205, which is one of the functions implemented by the control unit 100 via a program, may display a message as well as the table number, in the notification instruction. A file of this message may be stored in the memory unit 101. A plurality of patterns of messages may be stored.

If the customer for which the skeleton data M has been generated temporarily leaves the seat, the control unit 100 may access the timepiece unit 102. If the customer does not return even after a preset time has passed, the control unit 100 may form a message describing that the customer has not returned to the seat, as a part of the notification instruction, and transmit this notification instruction to the notification unit 30.

If the control unit 100 detects feature data of an article that is not a plate, a glass or the like on the table after the customer has finished using the table, the control unit 100 may transmit a message that there is an object left behind by the customer to the notification unit 30.

While some embodiments have been described, these embodiments are presented simply as examples and are not intended to limit the scope of the present disclosure. These novel embodiments can be carried out in various other forms and can include various omissions, replacements, and changes without departing from the spirit and scope of the present disclosure. These embodiments and the modifications thereof are included in the spirit and scope of the present disclosure and also included in the scope of the claims and equivalents thereof.

What is claimed is:

1. A customer monitoring device, comprising:
a communication interface configured to receive video data; and
a processor configured to:
extract feature data of an article on a table from the video data;
recognize the article on the table based on the extracted feature data;
set an article flag in a data record associated with the table to a positive value if the article on the table is recognized as an empty plate or empty glass;
extract feature data of a person proximate to the table from the video data;
estimate a skeleton position of the person and generate skeleton data for the person;
set a first operation flag in the data record to a positive value if the generated skeleton data indicates the person has performed a first ordering action; and
output a notification instruction to a notification unit if at least one of the article flag and the first operation flag in the data record is a positive value.

2. The customer monitoring device according to claim 1, wherein the first ordering action is raising a hand.

3. The customer monitoring device according to claim 1, wherein the first ordering action is bending an arm beyond a preset angle limit.

4. The customer monitoring device according to claim 1, wherein the processor is configured to output the notification instruction after a preset time interval if at least one of the article flag in the data record is a positive value.

5. The customer monitoring device according to claim 1, wherein the processor is further configured to recognize a glass being held in a hand of the person based on extracted feature data.

6. The customer monitoring device according to claim 5, wherein the first ordering action is bending an arm beyond a preset angle limit without a glass being held in the hand of the person.

7. The customer monitoring device according to claim 1, wherein the processor is further configured to:
set a second operation flag in the data record to a positive value if the generated skeleton data indicates the person has performed a second ordering action different from the first ordering action; and
output the notification instruction to the notification unit if the second first operation flag in the data record is a positive value.

8. A customer monitoring system for restaurants, the system comprising:
a camera positioned to image a table and a table proximity;
a notification device; and
a monitoring device including:
a communication interface configured to receive video data from the camera; and
a processor configured to:
extract feature data of an article on the table from the video data;
recognize the article on the table based on the extracted feature data;
set an article flag in a data record associated with the table to a positive value if the article on the table is recognized as an empty plate or empty glass;
extract feature data of a person proximate to the table from the video data;
estimate a skeleton position of the person and generate skeleton data for the person;
set a first operation flag in the data record to a positive value if the generated skeleton data indicates the person has performed a first ordering action; and
output a notification instruction to the notification device if at least one of the article flag and the first operation flag in the data record is a positive value.

9. The customer monitoring system according to claim 8, wherein the first ordering action is raising a hand.

10. The customer monitoring system according to claim 8, wherein the first ordering action is bending an arm beyond a preset angle limit.

11. The customer monitoring system according to claim 8, wherein the processor is configured to output the notification instruction after a preset time interval if at least one of the article flag in the data record is a positive value.

12. The customer monitoring system according to claim 8, wherein the processor is further configured to recognize a glass being held in a hand of the person based on extracted feature data.

13. The customer monitoring system according to claim 12, wherein the first ordering action is bending an arm beyond a preset angle limit without a glass being held in the hand of the person.

14. The customer monitoring system according to claim 8, wherein the notification device is a display screen.

15. The customer monitoring system according to claim 8, wherein the notification device is a lamp associated with the table.

16. The customer monitoring system according to claim 8, wherein the processor is further configured to:
set a second operation flag in the data record to a positive value if the generated skeleton data indicates the person has performed a second ordering action different from the first ordering action; and
output the notification instruction to the notification device if the second first operation flag in the data record is a positive value.

17. A customer monitoring method, comprising:
extracting feature data of an article on a table from video data;
recognizing the article on the table based on the extracted feature data;
setting an article flag in a data record associated with the table to a positive value if the article on the table is recognized as an empty plate or empty glass;
extracting feature data of a person proximate to the table from the video data;
estimating a skeleton position of the person and generating skeleton data for the person;
setting a first operation flag in the data record to a positive value if the generated skeleton data indicates the person has performed a first ordering action; and
outputting a notification instruction to a notification unit if at least one of the article flag and the first operation flag in the data record is a positive value.

18. The customer monitoring method according to claim 17, further comprising:
setting a second operation flag in the data record to a positive value if the generated skeleton data indicates the person has performed a second ordering action different from the first ordering action; and
outputting the notification instruction to the notification unit if the second first operation flag in the data record is a positive value.

19. The customer monitoring method according to claim 18, wherein the first ordering action is raising a hand.

20. The customer monitoring method according to claim 19, wherein the second ordering action is bending an arm beyond a preset angle limit.
